(19) United States
(12) Patent Application Publication
(10) Pub. No.: US 2013/0104215 A1
(43) Pub. Date: Apr. 25, 2013

(54) SYSTEM AND METHOD FOR MANAGING NETWORK DEVICES

(71) Applicant: Chung-Cheng Cheng, Taipei (TW)

(72) Inventor: Chung-Cheng Cheng, Taipei (TW)

(73) Assignee: QSAN TECHNOLOGY, INC., Taipei (TW)

(21) Appl. No.: 13/548,170

(22) Filed: Jul. 12, 2012

(30) Foreign Application Priority Data
Oct. 19, 2011 (TW) 100137897

(51) Int. Cl. G06F 15/173; H04L 9/32

(52) U.S. Cl. 726/7; 709/223

(57) ABSTRACT

A system and a method for managing network devices are provided. The method includes the following steps. A central server is connected to a plurality of authenticated network devices via a network interface. The MAC (Media Access Control) address and the corresponding Internet Protocol (IP) address are stored in a database of the central server. The central server uses the MAC address to identify each authenticated network device. The central server periodically detects whether the IP address of each authenticated network device is changed. If the IP address of one or more of the authenticated network devices is changed, the central server updates the IP address corresponding to the MAC address stored in the database according to the changed IP address.

### CROSS-REFERENCE TO RELATED APPLICATION

This application claims the priority benefit of Taiwan application serial no. 100137897, filed on Oct. 19, 2011. The entirety of the above-mentioned patent application is hereby incorporated by reference herein and made a part of this specification.

### BACKGROUND OF THE INVENTION

1. Field of the Invention

The present invention relates to a system and a method for managing network devices, in particular, to a system and a method for managing network devices in a one-to-many manner by a central server.

2. Description of Related Art

In the prior art, when a central management system manages a plurality of network devices at the same time, the central management system should authenticate each network device to be managed. At this time, when an Internet Protocol Address (IP Address) of a certain network device is changed, the central management system cannot know a new IP address of the network device. It is required to update and reconnect through manual control of a user and perform the authentication again, and then the network device can be continuously managed. In other words, when the IP address of a managed network device is changed, the network device should be re-authenticated in the prior art, which causes a lot of inconvenience for the user, thus reducing use efficiency of the network device.

### SUMMARY OF THE INVENTION

Accordingly, the present invention is directed to a system and a method for managing authenticated network devices, which uses a Media Access Control (MAC) address to identify the authenticated network device, so that even if the IP address of the authenticated network device is changed, it is not required to re-authenticate the network device.

The present invention provides a system for managing authenticated network devices, which includes a plurality of authenticated network devices and a central server. The central server is connected to the multiple authenticated network devices via a first network interface. MAC addresses of the multiple authenticated network devices and IP addresses corresponding to the MAC addresses are stored in a database of the central server, and the central server identifies each authenticated network device according to the MAC address of each authenticated network device. The central server periodically detects whether the IP address of each authenticated network device is changed. When one or more IP addresses of the multiple authenticated network devices are changed, the central server updates the IP addresses corresponding to the MAC addresses in the database according to the changed IP addresses.

In an embodiment of the present invention, the system for managing the authenticated network devices further includes: when a user equipment accesses the central server, the user equipment automatically obtains the updated IP address and is connected to one or more of the authenticated network devices via a second network interface according to the updated IP address.

In an embodiment of the present invention, the second network interface supports a Peer-to-Peer Communication Protocol.

In an embodiment of the present invention, the system for managing the authenticated network devices further include: the central server provides an account number and password for the user equipment for access, and the central server determines a specific authenticated network device falling within the account number in the multiple authenticated network devices according to the account number, where the account number has an access right for the specific authenticated network device.

In an embodiment of the present invention, the central server provides an Access Control List for showing an access right of each account number for each authenticated network device.

In an embodiment of the present invention, the step of the central server determining whether the IP address of one or more of the multiple authenticated network devices is changed includes: in a specific network domain, determining whether the IP addresses of the multiple authenticated network devices are changed through polling by the central server.

In an embodiment of the present invention, the polling is executed through using a Service Location Protocol (SLP) in the first network interface by the central server.

The present invention provides a method for managing authenticated network devices, which includes the following steps: a central server is connected to multiple authenticated network devices via a first network interface, where MAC addresses of the multiple authenticated network devices and IP addresses corresponding to the MAC addresses are stored in a database of the central server; the central server identifies each authenticated network device according to the MAC address of each authenticated network device; the central server periodically detects whether the IP address of each authenticated network device is changed; when one or more IP addresses of the multiple authenticated network devices are changed, the central server updates the IP addresses corresponding to the MAC addresses in the database according to the changed IP addresses.

On the basis of the above description, the present invention provides a system and a method for managing the network devices, so as to search the devices on the network through the SLP and identify each authenticated network device managed by the central server via the MAC address. When the IP address of one or more authenticated network devices is changed, the central server may re-obtain the new IP address, and does not authenticate the authenticated network devices again.

In order to make the features and advantages of the present invention more comprehensible, the present invention is further described in detail in the following with reference to the embodiments and the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of a system for managing network devices according to an embodiment of the present invention.

FIG. 1B is a block diagram of a system for managing network devices according to another embodiment of the present invention.

FIG. 2A is a flow chart of a method for managing network devices according to an embodiment of the present invention.

FIG. 2B is a flow chart of a method for managing network devices according to another embodiment of the present invention.

FIG. 2C is a flow chart of a method for managing network devices according to another embodiment of the present invention.

FIG. 2D is a flow chart of a method for managing network devices according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

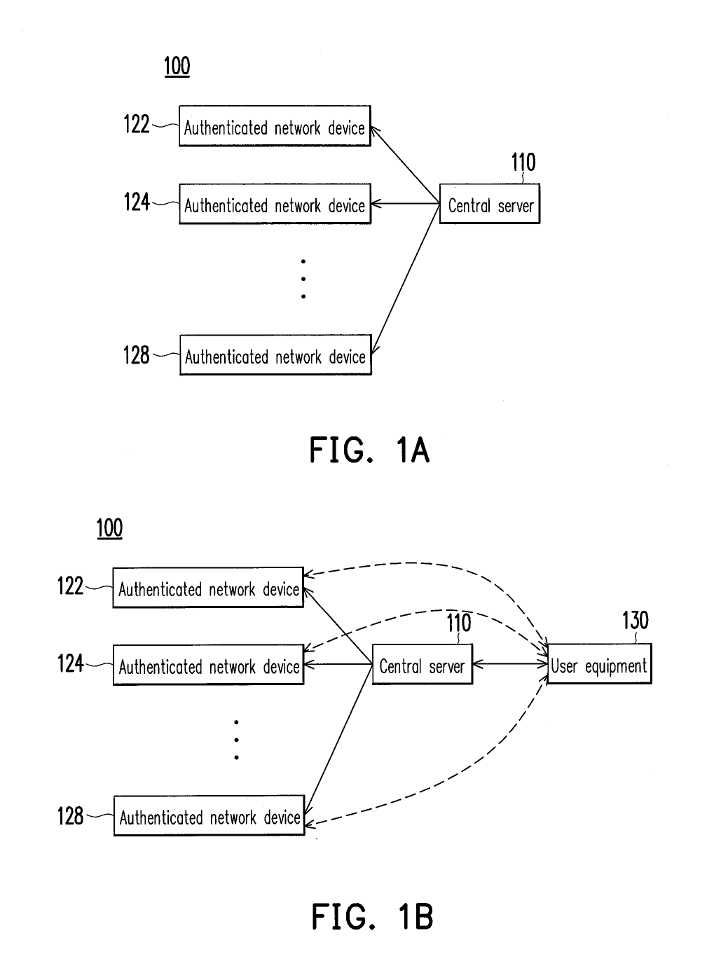

FIG. 1A is a block diagram of a system for managing network devices according to an embodiment of the present invention. The system 100 for managing the network devices includes a central server 110 and a plurality of authenticated network devices 122-128. The central server 110 may be a computer device having a central server and a network connection function such as a notebook computer, a panel computer, a tablet computer or a large-scale computer, and the authenticated network devices 122-128 are electronic devices authenticated by the central server 110 and may be a cloud storage device (for example, network hardware).

FIG. 1B is a block diagram of a system for managing authenticated network devices according to another embodiment of the present invention. An architecture difference of FIG. 1B and FIG. 1A lies in that, the system in FIG. 1B further includes a user equipment 130. The user equipment 130 may access the central server 110 and obtain information of IP addresses of the authenticated network devices 122-128, and is connected to each of the authenticated network devices 122-128 through the corresponding IP address provided by the central server 110.

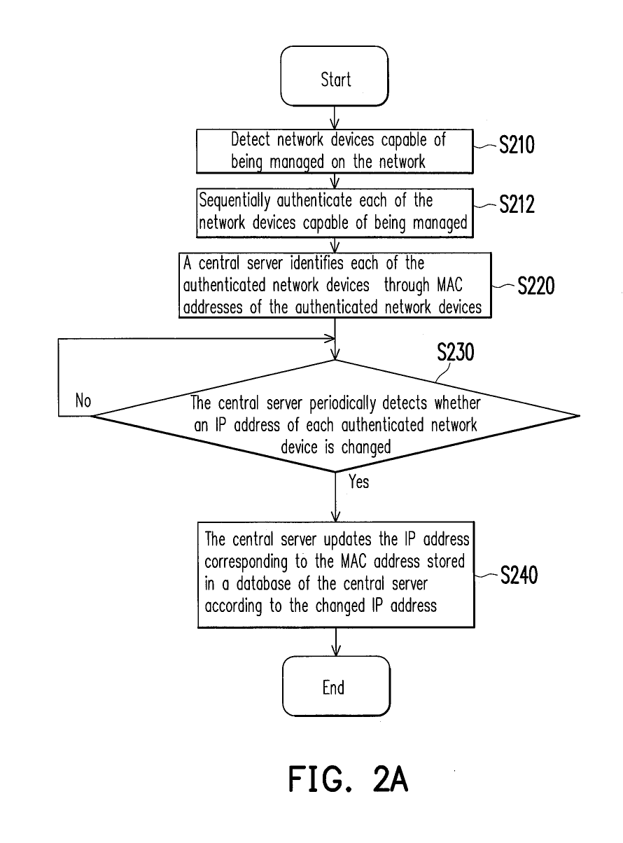

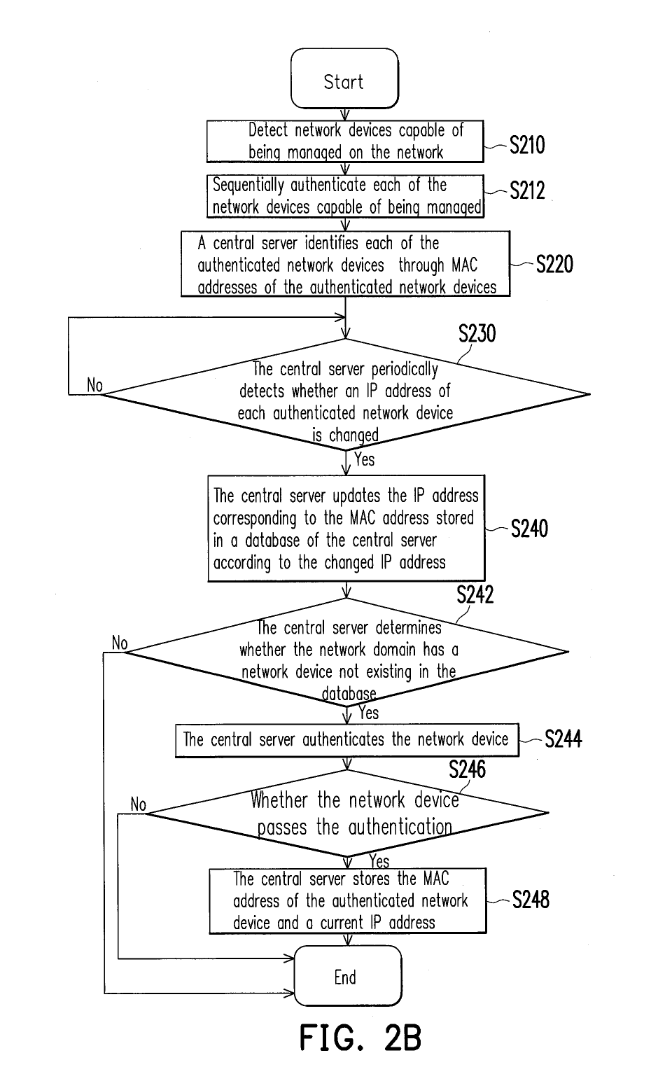

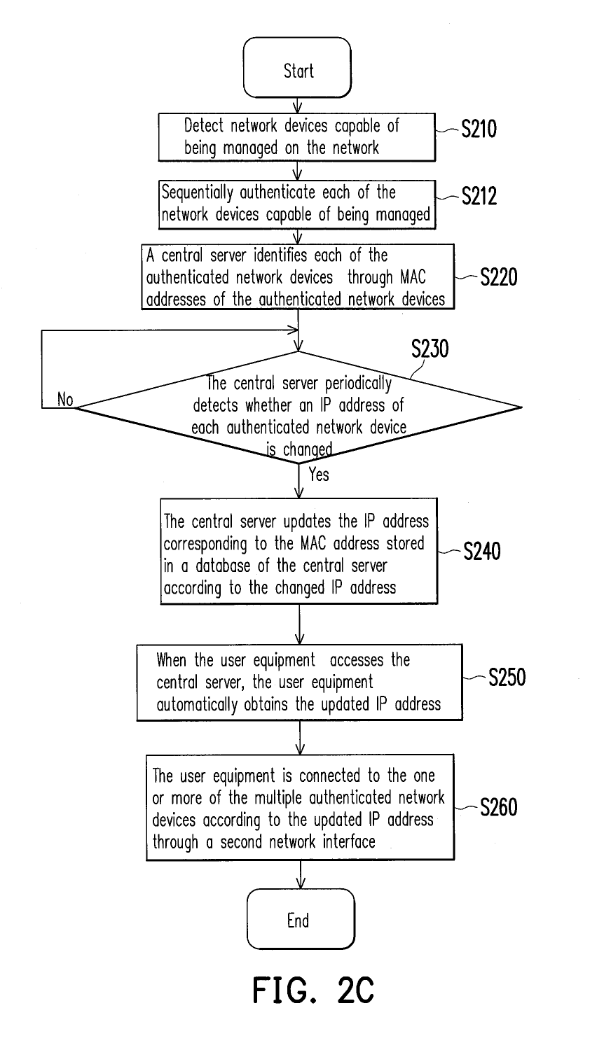

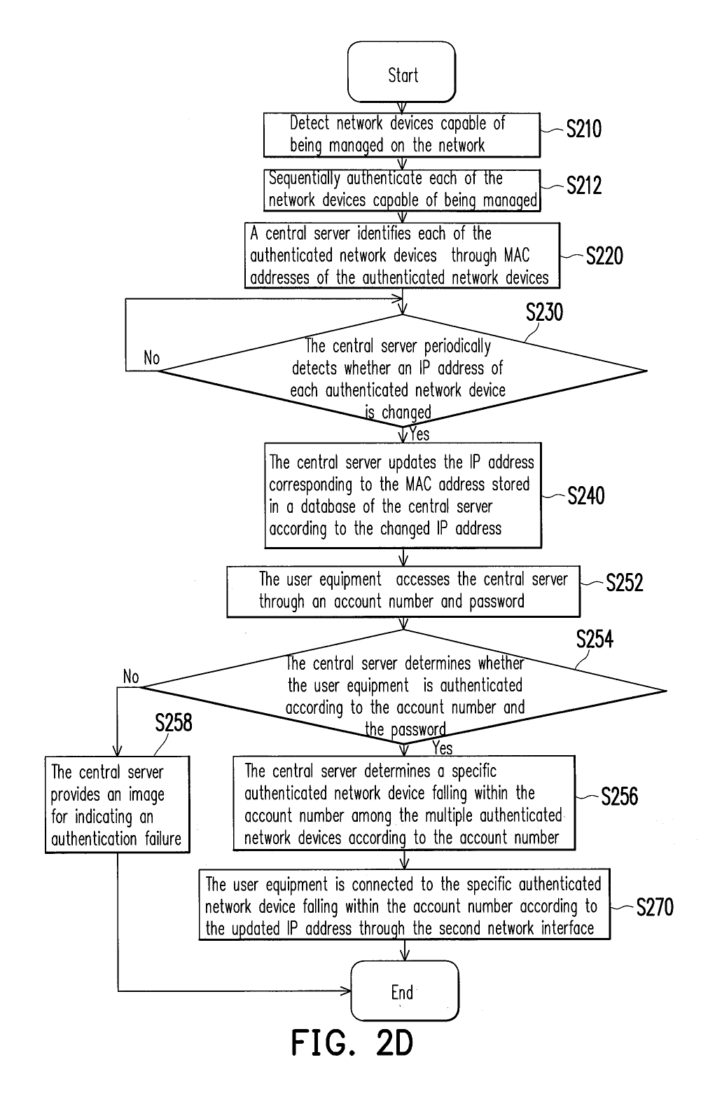

FIG. 2A is a flow chart of a method for managing network devices according to an embodiment of the present invention. Referring to FIG. 1A and FIG. 2A, first, network devices capable of being managed on the network are detected (step S210), and then, each of the network devices capable of being managed is sequentially authenticated (step S212). Afterwards, a central server 110 identifies each of the authenticated network devices 122-128 through MAC addresses of the authenticated network devices 122-128 (step S220). The central server 110 periodically detects whether an IP address of each authenticated network device is changed (step S230).

In a detailed process in step S230, in an embodiment, in a specific network domain, the central server 110 executes a polling operation by using an SLP at a first network interface. The polling operation can determine whether each of the authenticated network devices 122-128 is booted in the specific network domain, and can also determine whether the IP addresses of the multiple authenticated network devices 122-128 are changed.

If it is determined that the device is booted in step S230, the central server 110 updates the IP address corresponding to the MAC address stored in a database of the central server 110 according to the changed IP address (step S240).

FIG. 2B is a flow chart of a method for managing network devices according to another embodiment of the present invention. A part of the steps in FIG. 2B is the same as that in FIG. 2A, the difference is merely described herein. Referring to FIG. 2A and FIG. 2B, after step S240, the method further includes: the central server 110 determines whether the network domain has a network device not existing in the database (step S242). When it is determined that the network domain has a network device not existing in the database, the central server 110 authenticates the network device (step S244), and then determines whether the network device passes the authentication (step S246). If it is determined that he network device passes the authentication in step S246, the central server 110 stores the MAC address of the authenticated network device and a current IP address (step S248). That is to say, the central server 110 merely manages the authenticated network device. If in step S230, the central server 110 finds a network device not authenticated and not existing in the database of the central server 110 during the polling through the SLP, the central server 110 needs to first authenticate the network device and then manage the network device.

FIG. 2C is a flow chart of a method for managing network devices according to another embodiment of the present invention. A part of the steps thereof is the same as that in FIG. 2A, and the difference is merely described herein. Referring to FIG. 1B and 2C, after step S240, the method further includes: when the user equipment 130 accesses the central server 110, the user equipment 130 automatically obtains the updated IP address (step S250). The user equipment 130 is connected to the one or more of the multiple authenticated network devices 122-128 according to the updated IP address through a second network interface (step S260). The second network interface supports a Peer-to-Peer Communication Protocol. In other words, the user equipment 130 can be connected to one or more of the multiple authenticated network devices 122-128 according to the updated IP address through the Peer-to-Peer Communication Protocol.

FIG. 2D is a flow chart of a method for managing network devices according to another embodiment of the present invention. A part of the steps thereof is the same as that in FIG. 2A, and the difference is merely described herein. Referring to FIG. 1B and FIG. 2D, after step S240, the user equipment 130 accesses the central server 110 through an account number and password (step S252), and then the central server 110 determines whether the user equipment 130 is authenticated according to the account number and the password (step S254). If it is determined that the user equipment 130 is not authenticated in step S254, the central server 110 provides an image for indicating an authentication failure (step S258), which means that the user has no right to access the central server 110. If it is determined that the user equipment 130 is authenticated in step S254, the central server 110 determines a specific authenticated network device falling within the account number among the multiple authenticated network devices 122-128 according to the account number, that is, the account number has an access right of the specific authenticated network device (step S256). The user equipment 130 is connected to the specific authenticated network device falling within the account number according to the updated IP address through the second network interface (step S270).

In the embodiment described in FIG. 2D, modified examples of other forms also exist. For example, after step S240, when the central server 110 determines that the accessed account number of the user passes the authentication, the central server 110 provides an Access Control List for showing an access right of each account number for each authenticated network device. The user can know the access right for some specific authenticated network devices in the Access Control List. In other embodiments, the account number of each user may be grouped, each group may include a part of authenticated account numbers of the users, and the Access Control List shows the access right of each group for the authenticated network device.

On the basis of the above description, the present invention provides a system and a method for managing the network devices, so as to search the devices on the network through the SLP and identify each authenticated network device managed by the central server via the MAC address. When the IP address of one or more authenticated network devices is changed, the central server may re-obtain the new IP address, and does not authenticate the authenticated network devices again. When a user equipment accesses the central server through an account number and password, the user equipment automatically obtains the updated IP address and then is connected to one or more of the multiple authenticated network devices according to the updated IP address through the network interface. In addition, the central server uses the Access Control List to show the access right of each account number for each authenticated network device. After the user accesses the central server, the user can clearly know the access right for some authenticated network devices from the Access Control List.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for managing authenticated network devices, comprising:
a plurality of authenticated network devices; and
a central server, connected to the multiple authenticated network devices via a first network interface, wherein Media Access Control (MAC) addresses of the multiple authenticated network devices and Internet Protocol (IP) addresses corresponding to the MAC addresses are stored in a database of the central server, the central server identifies each authenticated network device according to the MAC address of each authenticated network device, periodically detects whether the IP address of each authenticated network device is changed, and when one or more IP addresses of the multiple authenticated network devices are changed, updates the IP addresses corresponding to the MAC addresses in the database according to the changed IP addresses.

2. The system for managing authenticated network devices according to claim 1, further comprising: when a user equipment accesses the central server, the user equipment automatically obtains the updated IP address and is connected to one or more of the authenticated network devices via a second network interface according to the updated IP address.

3. The system for managing authenticated network devices according to claim 2, wherein the second network interface supports a Peer-to-Peer Communication Protocol.

4. The system for managing authenticated network devices according to claim 1, further comprising: the central server provides an account number and password for the user equipment for access, and the central server determines a specific authenticated network device falling within the account number in the multiple authenticated network devices according to the account number, wherein the account number has an access right for the specific authenticated network device.

5. The system for managing authenticated network devices according to claim 4, wherein the central server provides an Access Control List for showing an access right of each account number for each authenticated network device.

6. The system for managing authenticated network devices according to claim 1, wherein the step of the central server determining whether the IP address of one or more of the multiple authenticated network devices is changed comprises: in a specific network domain, determining whether the IP addresses of the multiple authenticated network devices are changed through polling by the central server.

7. The system for managing authenticated network devices according to claim 6, wherein the polling is executed through using a Service Location Protocol (SLP) in the first network interface by the central server.

8. A method for managing authenticated network devices, comprising:
connecting a central server to multiple authenticated network devices via a first network interface, wherein Media Access Control (MAC) addresses of the multiple authenticated network devices and Internet Protocol (IP) addresses corresponding to the MAC addresses are stored in a database of the central server;
identifying each authenticated network device through using the MAC address of each authenticated network device by the central server;
periodically detecting whether the IP address of each authenticated network device is changed by the central server; and
when one or more IP addresses of the multiple authenticated network devices are changed, updating the IP addresses corresponding to the MAC addresses in the database according to the changed IP addresses by the central server.

9. The method for managing authenticated network devices according to claim 8, further comprising:
when a user equipment accesses the central server, automatically obtaining the updated IP address by the user equipment; and
connecting the user equipment to one or more of the multiple authenticated network devices through a second network interface according to the updated IP address.

10. The method for managing authenticated network devices according to claim 9, wherein the second network interface supports a Peer-to-Peer Communication Protocol.

11. The method for managing authenticated network devices according to claim 8, further comprising:
providing an account number and password for the user equipment for access by the central server; and
determining a specific authenticated network device falling within the account number in the multiple authenticated network devices according to the account number by the central server, wherein the account number has an access right for the specific authenticated network device.

12. The method for managing authenticated network devices according to claim 11, wherein the central server provides an Access Control List for showing an access right of each account number for each authenticated network device.

13. The method for managing authenticated network devices according to claim 8, wherein the step of the central server determining whether the IP address of one or more of the multiple authenticated network device is changed by the central server comprises:
in a specific network domain, determining whether the IP addresses of the multiple authenticated network devices are changed through polling by the central server.

14. The method for managing authenticated network devices according to claim 13, wherein the polling is executed through using a Service Location Protocol (SLP) in the first network interface by the central server.
